(19) United States
(12) Patent Application Publication
(10) Pub. No.: US 2026/0074464 A1
(43) Pub. Date: Mar. 12, 2026

(54) BATTERY CONNECTOR

(71) Applicant: DELTA ELECTRONICS, INC., Taoyuan City (TW)

(72) Inventors: Yu-Se LIU, Taoyuan City (TW); Chung-Hwa WEI, Taoyuan City (TW)

(21) Appl. No.: 18/863,996

(22) PCT Filed: Jun. 6, 2024
(86) PCT No.: PCT/CN2024/097769

§ 371 Date: Nov. 7, 2024

Related U.S. Application Data
(60) Provisional application No. 63/524,320, filed on Jun. 30, 2023.

(30) Foreign Application Priority Data
Oct. 27, 2023 (CN) 202322893666.1

(51) Int. Cl. H01R 13/629; H01R 13/502

(52) U.S. Cl. CPC H01R 13/629; H01R 13/502

(57) ABSTRACT

A battery connector having a terminal holder, a connecting terminal, a guiding column, a first cover, a second cover, and an elastic member is provided. The connecting terminal is arranged on the terminal holder. The guiding columns is arranged on the terminal holder and formed on two sides of the connecting terminals. The first cover and the second cover accommodate the terminal holder. The second cover has a terminal hole for the connecting terminal outstretching or retracting therein. The elastic member is arranged between the first cover and the second cover. In a disconnected state, the connecting terminal is received within the second cover, at least a portion of the guiding column is exposed outside the second cover. In a connected state, the connecting terminals move along an axial direction of the guiding column to be exposed outside the second cover.

### CROSS-REFERENCE TO RELATED APPLICATIONS

This application is the National Phase of PCT International Application No. PCT/CN2024/097769 filed on Jun. 6, 2024, which claims priority to China Patent Application No. 202322893666.1 filed on Oct. 27, 2023 and U.S. Provisional Application No. 63/524,320 filed on Jun. 30, 2023. The entire disclosures of the above applications are all incorporated herein by reference.

### BACKGROUND

### Technical Field

The present disclosure relates to connector field, particularly to a battery connector.

### Description of Related Art

Existing electric vehicles inevitably has decreased power from the power supply device (such as battery) after being used for a period of time, thus the power supply device must be charged by a power supply equipment (such as charging station). The connection terminals of the battery connector of the existing power supply equipment are exposed such that the user may align the corresponding holes of the battery to connect for charging. However, the exposed connection terminals of the battery connector have sharp edges and electrical problems, which not only easily causes user injure or object damage during operation, but also causes electric shock or affect the transmission of electrical signals.

In view of the above, the inventor seeks to overcome the aforementioned drawbacks associated with the current technology and aims to provide an effective solution through extensive researches along with utilization of academic principles and knowledge.

### SUMMARY

The primary objective of the present disclosure is to solve technical problems with existing battery connector.

To accomplish the aforementioned objective, the present disclosure provides a battery connector configured to be plugged in a corresponding connector of a battery having two guiding holes and a plurality of terminal slots. The battery connector comprises a terminal holder, a plurality of connecting terminals, at least two guiding columns, a first cover, a second cover, and an elastic member. The plurality of connecting terminals is arranged on the terminal holder in parallel. The at least two guiding columns is arranged on the terminal holder and respectively located on two sides of the connecting terminals. The first cover covers a side of the terminal holder. The second cover covers another side of the terminal holder to accommodate the terminal holder together with the first cover. The elastic member is arranged between the first cover and the second cover. In a disconnected state, the connecting terminals are received within the second cover, and at least a portion of the at least two guiding columns are exposed outside the second cover. In a connected state, the connecting terminals moves along an axial direction of the at least two guiding columns to be exposed outside the second cover.

When the battery connector of the present disclosure does not be connected to the corresponding connector, the elastic member pushes the second cover outward to keep the first cover and the second cover at an appropriate distance and make the connecting terminals to be hidden and contained within the second cover, so as to prevent the problems of sharp edges and electrical. When the battery connector contacts the corresponding connector, the connecting terminals outstretch from the terminal holes of the second cover to connect to the corresponding connector of the battery to charge and communicate. The battery connector is fixed to or detached from the corresponding connector through the fasten state or the release state between the guiding columns and the guiding holes. The present disclosure may add fastening and anti-detaching function in original design of guiding columns and the corresponding guiding holes without changing the design of the guiding holes of the corresponding connector. If the battery connector is moved directly in a direction of exiting the corresponding connector without proper operation when the battery and the battery are in the connected state (such as in charging), the rolling ball of the inner guiding rod and the corresponding connector are in the fasten state to further reduce malfunction causing the battery connector to be detachable. When the battery connector is moved in a direction of inserting the corresponding connector, the rolling ball of the inner guiding rod changes to the released state, the direction of force application is consistent with the direction of insertion to facilitate installation, and the connection security between the battery connector and the corresponding connector is increased.

### BRIEF DESCRIPTION OF THE DRAWINGS

FIG. 1 is an exploded view in one of embodiments of the battery connector of the present disclosure;

FIG. 2 is a perspective view of FIG. 1;

FIG. 3 is a perspective appearance view in one of embodiments of the battery connector of the present disclosure;

FIG. 4 is an exploded view of the guiding columns and the terminal holder in one of embodiments of the battery connector of the present disclosure;

FIG. 5 is a cross-sectional view of the press member, which has not been pressed, of the battery connector of the present disclosure and the corresponding connector;

FIG. 6 is a cross-sectional view of the press member, which has been pressed, of the battery connector of the present disclosure before connecting to the corresponding connector;

FIG. 7 is a cross-sectional view of the battery connector of the present disclosure after connecting to the corresponding connector; and

FIG. 8 is a cross-sectional view of the battery connector of the present disclosure after connecting to the corresponding connector and the guiding columns push the press member outward.

### DETAILED DESCRIPTION

The technical contents of the present disclosure will become apparent with the detailed description of embodiments and the accompanied drawings as follows. However, it shall be noted that the accompanied drawings are for illustrative purposes only such that they shall not be used to restrict the scope of the present disclosure.

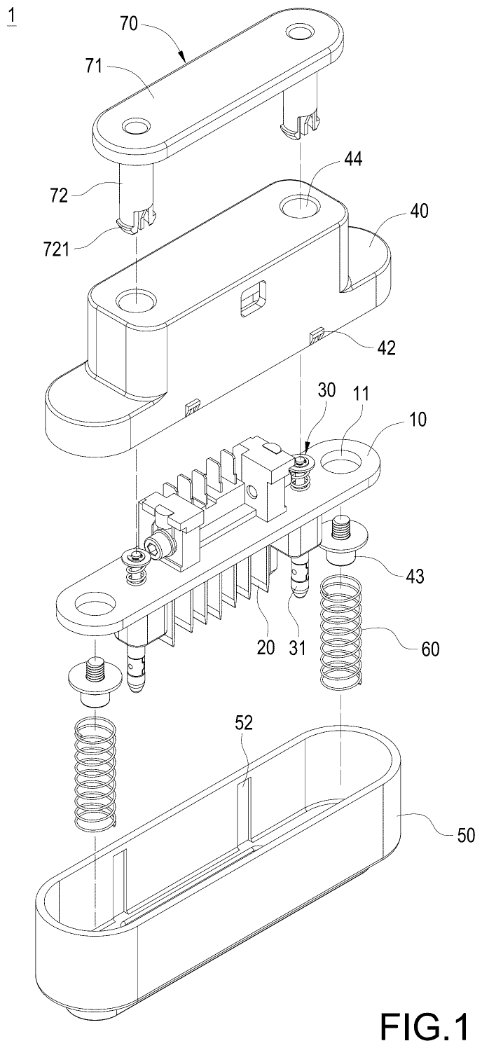

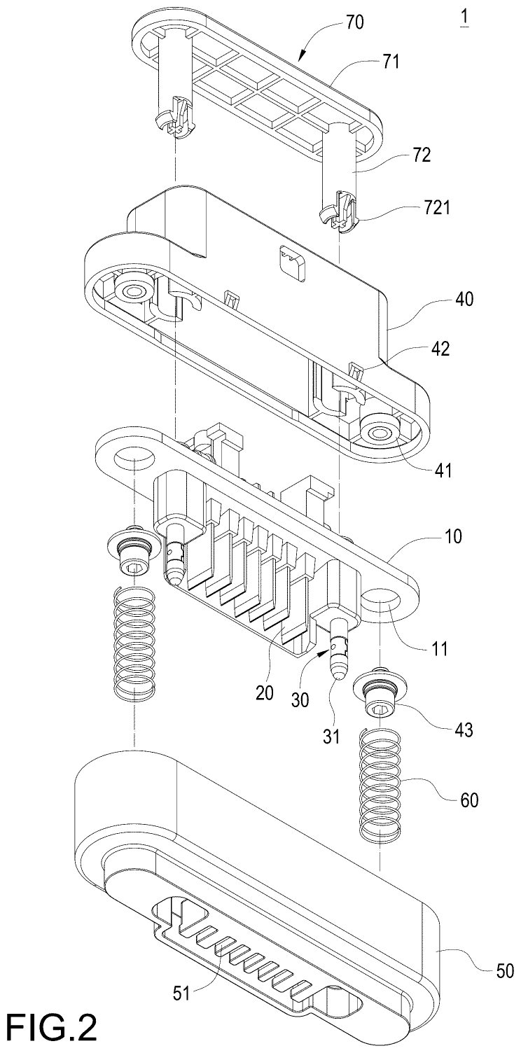

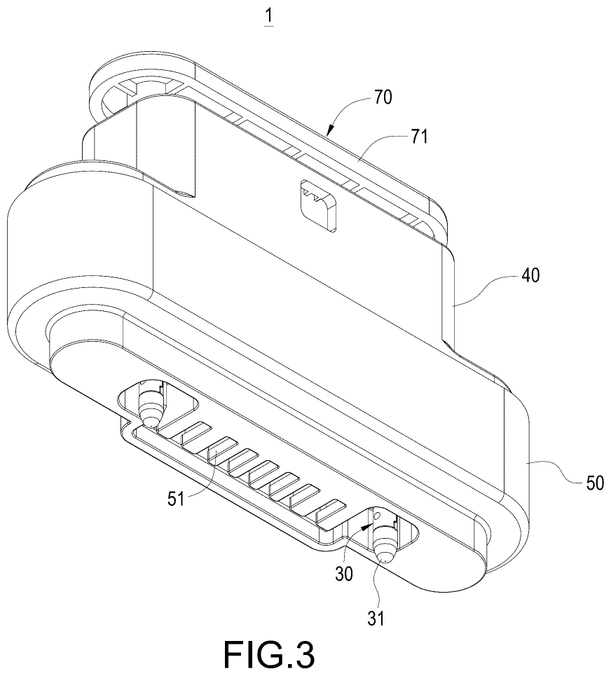

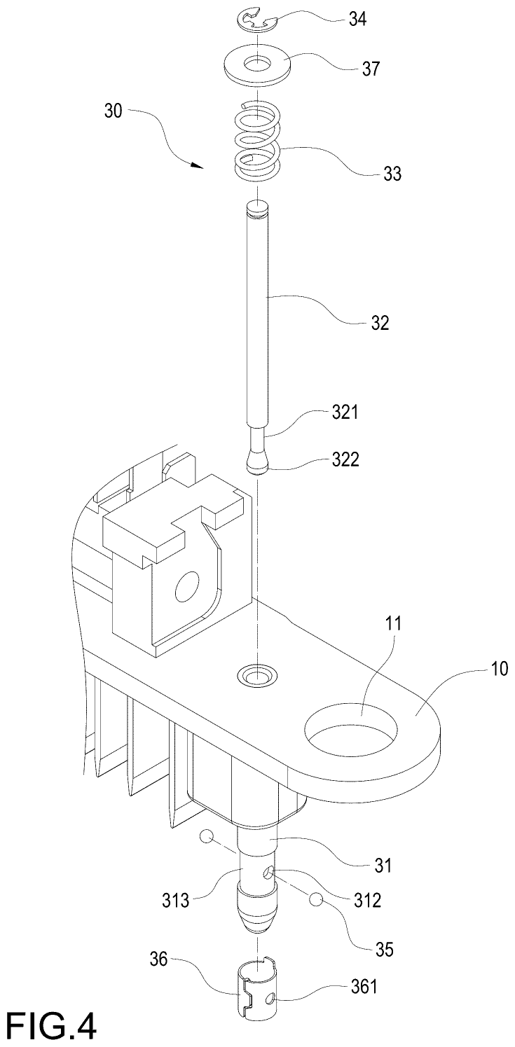

Please refer to the embodiment of FIG. 1, FIG. 2, FIG. 3 and FIG. 4, t he present disclosure provides a battery connector 1 used to transmit power or electrical signal to battery, power storing device, or other power consuming device. The battery connector 1 comprises a terminal holder 10, a plurality of connecting terminals 20, two guiding columns 30, a first cover 40, a second cover 50, and two elastic members 60.

A number and relative installation position of the components in the battery connector 1 may be appropriately adjusted according to different design considerations. In the embodiment of FIG. 1, FIG. 2, FIG. 3 and FIG. 4, the plurality of connecting terminals 20 are arranged on a middle area of the terminal holder 10 and are arranged side by side with appropriate distances (or predetermined) from each other. The connecting terminals 20 are made of a material with good electrical conductivity and are used for transmitting power and/or signals. In another embodiment, some of the connecting terminals 20 do not have the function of transmitting power or signals such that they may also be made of non-conductive materials. The two guiding columns 30 are arranged on the terminal holder 10 and are respectively located on two sides of the connecting terminals 20. In another embodiment, depending on the structural design of the battery connector 1, a number of the guiding column 30 may be one or a plurality, and the guiding columns 30 may also be arranged between the connecting terminals 20 or on one of four sides of the connecting terminals 20 (such as the side adjacent to the long side of the terminal holder 10 in FIG. 1) to provide auxiliary connection function. In another embodiment, the battery connector 1 comprises at least two guiding columns 30 to stably connect to the battery. The first cover 40 covers a top side of the terminal holder 10. The second cover 50 covers a bottom side of the terminal holder 10 and the second cover 50 correspondingly covers the first cover 40. A space formed by the second cover 50 covering the first cover 40 may accommodate the terminal holder 10. The second cover 50 has one or a plurality of terminal holes 51 for the connecting terminals outstretch or retract therein. The second cover 50 has two column holes (not labeled in figures) for a portion of the two guiding columns 30 exposed outside the second cover 50. The terminal holes 51 and the column holes may be dis-communicated, partially communicated or fully communicated (as shown in FIG. 2 and FIG. 3). The two elastic members 60 are arranged between the first cover 40 and the second cover 50 such that the first cover 40 and the second cover 50 keep an appropriate distance and make the connecting terminals 20 to be hidden and contained within the second cover 50.

When the battery connector 1 is in a disconnected state, the connecting terminals 20 are received within the second cover 50, and at least the portion of the at least two guiding columns 30 are exposed outside the second cover 50. When the battery connector 1 is in a connected state, the connecting terminals 20 may move along an axial direction of the two guiding columns 30 to be exposed outside the second cover 50.

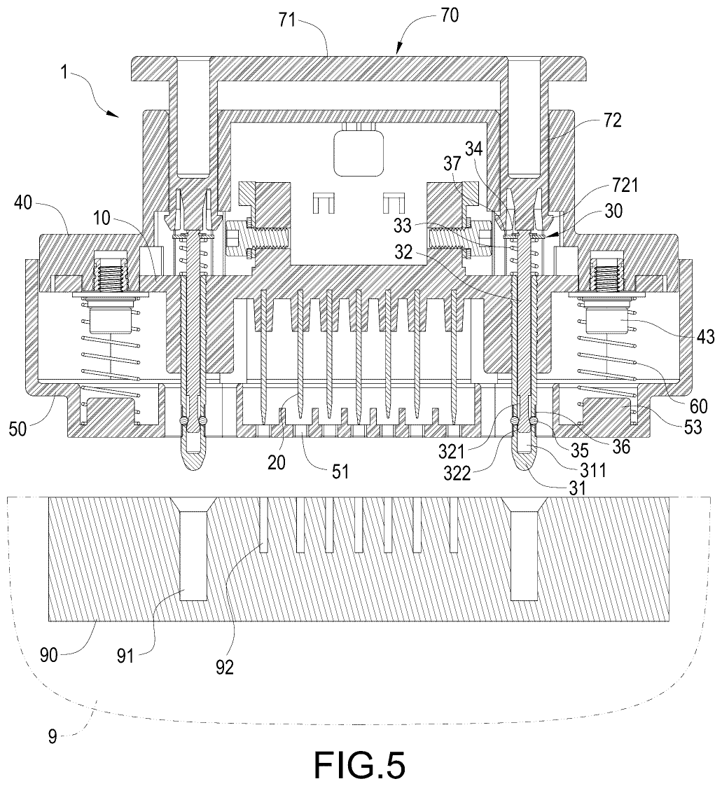

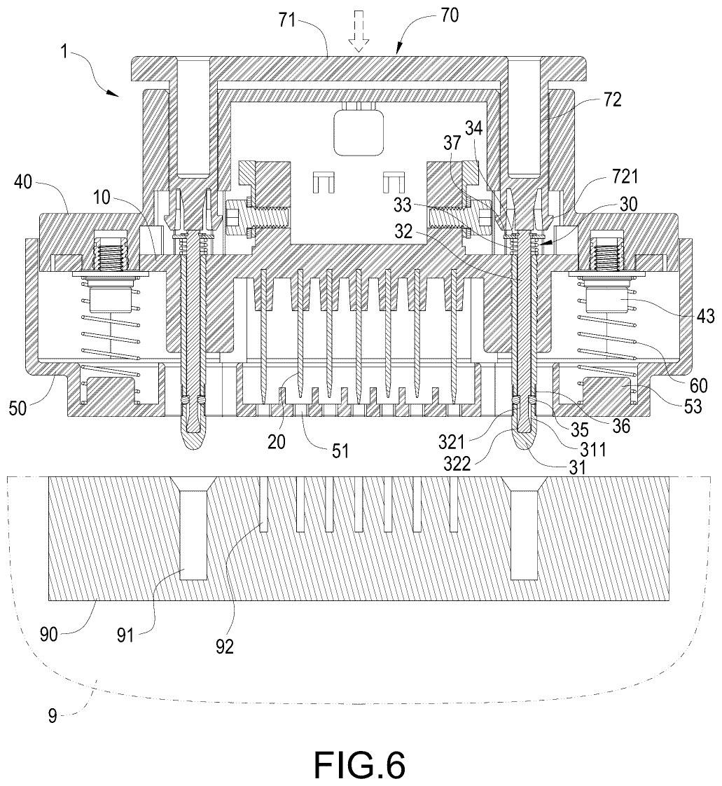

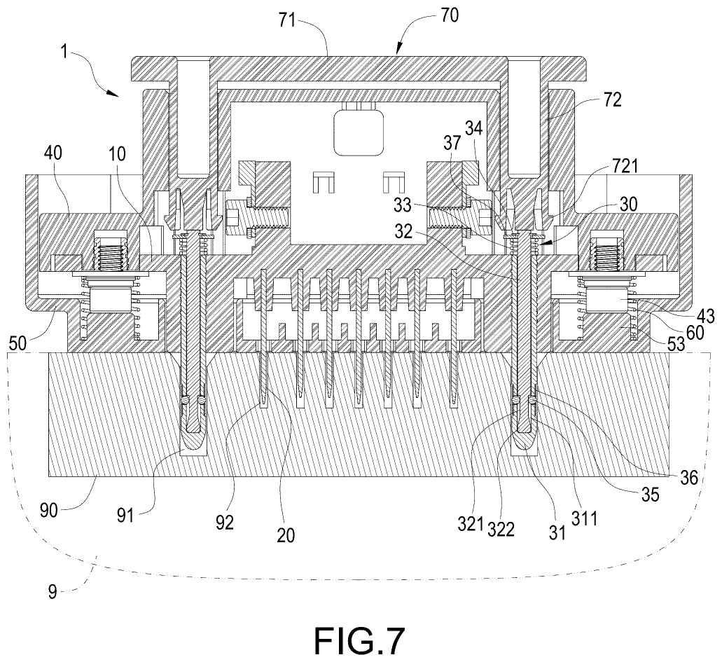

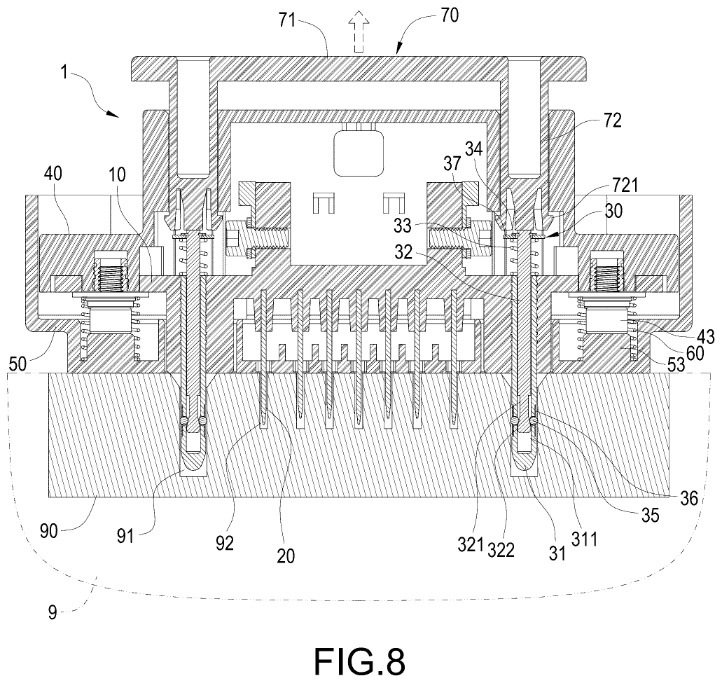

For convenience of description, the disconnected state is defined in that the connecting terminals 20 of the battery connector 1 are disconnected from a corresponding connector 90 (as shown in FIG. 5 and FIG. 6). The connected state is defined in that the battery connector 1 is connecting to the corresponding connector 90 of a battery 9, or the battery connector 1 is connected to the corresponding connector 90 of the battery 9 and achieves electrical conduction (as shown in FIG. 7 and FIG. 8).

In the embodiment, the terminal holder 10 is made of insulation material. The two guiding columns 30 of the terminal holder 10 has two fixing hole 11 respectively located on a left side and a right side of the two guiding columns 30. The first cover 40 has two convex column 41 extending respectively corresponding to the fixing holes 11. The convex columns 41 are for the fixing hole 11 sleeving on the convex columns 41.

Please refer to FIG. 5, FIG. 6, FIG. 7, and FIG. 8 together. In the embodiment, each of the guiding columns 30 comprises an outer guiding rod 31, an inner guiding rod 32, a spring 33, a snap ring 34, two rolling balls 35, and a sleeve 36. One end of the outer guiding rod 31 is fixed to the terminal holder 10, another end of the outer guiding rod 31 is extended in a direction away from the terminal holder 10. The outer guiding rod 31 has a center hole 311 and an accommodated hole 312. In the embodiment, the center hole 311 is an axial blind hole, an opening of the blind hole is located at the end of the outer guiding rod 31 fixed to the terminal holder 10, and the accommodated hole 312 penetrates through the outer guiding rod 31 in a radial direction and is communicated to the center hole 311.

The inner guiding rod 32 is inserted in the center hole 311 of the outer guiding rod 31. The inner guiding rod 32 comprises a release portion 321 and a fasten portion 322. The release portion 321 is located at a bottom end of the inner guiding rod 32, and the fasten portion 322 is extended from the release portion 321 (along the axial direction). A diameter of the release portion 321 is smaller than a diameter of the fasten portion 322. In one of the embodiments, a diameter of a junction between the release portion 321 and the fasten portion 322 is gradually increased from the release portion 321 to the fasten portion 322.

The spring 33 and the snap ring 34 are sleeving on an end of the outer guiding rod 32 adjacent to the terminal holder 10. The spring 33 is arranged between the snap ring 34 and the terminal holder 10. The two rolling balls 35 are respectively arranged in the accommodated hole 312 and covered by the sleeve 36. The sleeve 36 has an opening 361 (located on a radial direction thereof) such that the two rolling balls 35 may respectively partially expose outside an outer surface of the outer guiding rod 31 through the opening 361. A number of the rolling ball 35 may be one or a plurality. A number of the opening 361 of the sleeve 36 may be greater than or equal to the number of the rolling ball 35. The outer guiding rod 31 has a concave area 313 adjacent to a location of the accommodated hole 312. The sleeve 36 is sleeving on the concave area 313. The opening 361 is corresponding to a location of the accommodated hole 312 of the outer guiding rod 31, and a diameter of the opening 361 is smaller than a diameter of the rolling ball 35 such that the rolling balls 35 may move along the accommodated hole 312 without detaching therefrom and partially expose from the opening 361. Therefore, when the inner guiding rod 32 is inserted in the center hole 311 of the outer guiding rod 31, the inner guiding rod 32 may move relative to the outer guiding rod 31 such that the rolling balls 35 may be in a state of partially exposing from the opening 361 or in a state of retracting into the opening 361.

In the embodiment, each of the guiding columns 30 further comprises a washer 37. The washer 37 is sandwiched between a top portion of the spring 33 and the snap ring 34. The washer 37 is used to prevent the spring 33 from detaching with the inner guiding rod 32 such that the spring 33 may stably expand and retract correspondingly with the movement of the inner guiding rod 32. In another embodiment, the snap ring 34 may prevent the spring 33 from detaching with the inner guiding rod 32 such that the snap ring 34 does not need to be arranged in the guiding columns 30.

In the embodiment, the first cover 40 has a plurality of limiting hooks 42 located on an outer surface thereof, and the second cover 50 has a plurality of limiting grooves 52 corresponding to the plurality of limiting hooks 42. The limiting hooks 42 are embedded in the limiting hooks 42 for limiting a displacement distance of the first cover 40 and the second cover 50.

In the embodiment, the battery connector 1 further comprises two fixing members 43. Each of the fixing members 43 may be a screw or a rivet. The two fixing members 43 are respectively connected to the two convex columns 41 for fixing the terminal holder 10 to the first cover 40.

In the embodiment, the second cover 50 has two positioning members 53. The two positioning members 53 are respectively extended corresponding to the two convex columns 41. Each of the positioning members 53 may be a column or a hole. Two ends of each of the elastic members 60 are respectively sleeving on the fixing member 43 and the positioning member 53.

In the embodiment, each of the elastic members 60 is a compression spring.

In the embodiment, the battery connector 1 further comprises a press member 70. The first cover 40 has two shaft holes 44. The press member 70 mainly comprises a push plate 71 and two shafts 72 extended from the push plate 71. Each of the shafts 72 penetrates each of the shaft holes 44 of the first cover 40 and is used to push against each of the guiding columns 30 to perform connecting operation. A hook 721 is arranged on a bottom end of each of the shafts 72. Each of the hooks 721 is used to prevent each of the shafts 72 detaching from each of the shaft holes 44. In another embodiment, a number of the shaft 72 of the press member 70 may be greater than or equal to a number of the guiding column 30 such that each of the shafts 72 may push each of the guiding columns 30.

Please refer to FIG. 5, FIG. 6, FIG. 7, and FIG. 8 again, which show one embodiment of an assembly process of the battery connector 1 and the battery 9. Those figures only show part of the structure of the corresponding connector 90 in the battery 9 and omit other components in order to illustrate more clearly the operation of the battery connector 1 and the corresponding connector 90. In the embodiment, the corresponding connector 90 has two guiding holes 91 and a plurality of terminal slots 92. The battery connector 1 and the corresponding connector 90 achieve stable consolidation through each of the connecting terminals 20 and the two guiding columns 30 respectively inserting in each of the terminal slots 92 and the two guiding holes 91, such that the connecting terminals 20 supply the power to the battery 9 through the corresponding connector 90.

In the battery connector 1, by operating the press member 70 to push the guiding columns 30 to change a relative location of the rolling ball 35 and the inner guiding rod 32, a fasten state (the rolling ball 35 is fixed to the fasten portion 322 of the inner guiding rod 32) and a release state (the rolling ball 35 is located at the release portion 321 of the inner guiding rod 32) are defined between the two guiding columns 30 of the battery connector 1 and the two guiding holes 91 of the corresponding connector 90. In one of embodiments, when the battery connector 1 and the corresponding connector 90 of the battery 9 are in the disconnected state, the connecting terminals 20 are hidden and contained within the second cover 50, and at least the portion of the two guiding columns 30 are exposed outside the second cover 50. When the battery connector 1 is connecting to the corresponding connector 90 of the battery 9, the user may align the two guiding columns 30 with the two guiding holes 91 of the corresponding connector 90 (refer to FIG. 5) and press the press member 70 to push the two guiding columns 30, so as to make the rolling balls 35 to be located at the release portion 321 of the inner guiding rod 32 and make the two guiding columns 30 to be inserted in the two guiding holes 91. When the two guiding columns 30 are inserted in the two guiding holes 91 and the second cover 50 abuts against to or is adjacent to a surface of the battery 9, the user may press the press member 70 and/or the first cover 40 to shorten a distance between the second cover 50 and the first cover 40 such that each of the connecting terminals 20 of the terminal holder 10 may move along the axial direction of the two guiding columns 30 to be exposed outside the second cover 50 and be inserted in each of the terminal slots 92 of the corresponding connector 90. In the connecting process, the rolling balls 35 may be located at the release portion 321 of the inner guiding rod 32 to retract into the opening 361 through the press member 70 pushing the two guiding columns 30, and the connecting terminals 20 and the terminal slots 92 may be located at a connecting location through the two guiding columns 30 being inserted into a proper location of each of the guiding holes 91. When the battery connector 1 and the corresponding connector 90 of the battery 9 are located at the connecting location, the user may release the press member 70 (or reduce a pressing force on the press member 70) to make the rolling balls 35 to be fixed to the fasten portion 322 of the inner guiding rod 32 and partially exposed out of the opening 361 to abut against an inner wall of the guiding hole 91, such that the guiding columns 30 and the guiding holes 91 are in the fasten state to fix the battery connector 1 to the corresponding connector 90 of the battery 9. When the guiding columns 30 and the guiding holes 91 are in the fasten state and the battery connector 1 needs to be detached from the corresponding connector 90 of the battery 9, the user may press the press member 70 to push the guiding columns 30 to make the rolling balls 35 to be located at the release portion 321 of the inner guiding rod 32 to retract into the opening 361, such that the guiding columns 30 and the guiding holes 91 are in the release state to make the battery connector 1 to be detached from the corresponding connector 90 of the battery 9.

Please refer to FIG. 5 and FIG. 6 again. By operating the press member 70, when the user presses the push plate 71 first to make the push plate 71 to move toward the first cover 40, the two shafts 72 may move along the axial direction of the two shaft holes 44. After each of the shafts 72 respectively contacts a top end of each of the guiding columns 30, the two shafts 72 pushes the two inner guiding rods 32 to respectively move along the axial direction of each of the center holes 311 of each of the outer guiding rods 31. At the same time, the two rolling balls 35 move from the fasten portion 322 of the inner guiding rod 32 (as shown in FIG. 5) to the release portion 321 of the inner guiding rod 32 (as shown in FIG. 6) to retract into the opening 361, a resistance between the rolling ball 35 and a wall of the guiding hole 91 is reduced such that the two guiding columns 30 may be smoothly inserted into the two guiding holes 91.

Please refer to FOG. 7 and FIG. 8. When the battery connector 1 and the corresponding connector 90 of the battery 9 are in the connected state, the two inner guiding rods 32 move toward the two shafts 72 through an elastic recovery force of each of the springs 33. At the same time, the two rolling balls 35 move from the release portion 321 of the inner guiding rod 32 (as shown in FIG. 7) to be fixed to the fasten portion 322 of the inner guiding rod 32 (as shown in FIG. 8) to partially expose the opening 361, such that the two rolling balls 35 are fixed to the inner wall of the guiding hole 91 and the two guiding columns 30 and the two guiding holes 91 are in the fasten state. Therefore, a connection robustness and safety between the battery connector 1 and the corresponding connector 90 are enhanced.

The connection method mentioned above in FIG. 5, FIG. 6, FIG. 6, FIG. 7, and FIG. 8 is only a safer connection method. After the battery connector 1 and the corresponding connector 90 of the battery 9 are close enough, the user then operates the battery connector 1 to make the connecting terminals 20 to expose from the second cover 50 and be inserted the terminal slots 92 of the corresponding connector 90. Therefore, the present disclosure may prevent the user form contacting sharp metal edges of the connecting terminals 20 to reduce a possibility of injury, electric shock, or damaging the connecting terminals 20. In another embodiment, the aforementioned connection process may also be adjusted appropriately to enable the battery connector 1 to achieve the required functions. For example, when the battery connector 1 is connecting to the corresponding connector 90, the user may operate the press member 70 after the guiding columns 30 are aligned and inserted into the guiding holes 91 and the rolling balls 35 move to contact the inner wall of the guiding holes 91 to increase the resistance, such that the rolling balls move to the release portion 321 of the inner guiding rod 32 to make the guiding columns 30 to be inserted into the guiding holes 91 with lower resistance.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. A battery connector, configured to be plugged in a corresponding connector of a battery comprising two guiding holes and a plurality of terminal slots, comprising:
a terminal holder;
a plurality of connecting terminals, arranged on the terminal holder in parallel;
at least two guiding columns, arranged on the terminal holder and respectively located on two sides of the connecting terminals;
a first cover, covering a side of the terminal holder;
a second cover, covering another side of the terminal holder to accommodate the terminal holder together with the first cover; and
an elastic member, arranged between the first cover and the second cover;
wherein in a disconnected state, the connecting terminals are received within the second cover, and at least a portion of the at least two guiding columns are exposed outside the second cover; in a connected state, the connecting terminals moves along an axial direction of the at least two guiding columns to be exposed outside the second cover.

2. The battery connector according to claim 1, further comprising a press member, wherein the first cover comprises two shaft holes, the press member comprises two shafts, and each of the shafts penetrates each of the shaft holes for pushing each of the guiding columns.

3. The battery connector according to claim 2, wherein a hook is arranged at one end of each of the shafts for preventing each of the shafts from detaching with each of the shaft holes.

4. The battery connector according to claim 1, wherein the first cover comprises a plurality of limiting hooks, and the second cover comprises a plurality of limiting grooves for receiving the plurality of limiting hooks.

5. The battery connector according to claim 1, wherein the first cover comprises a convex column and the terminal holder comprises a fixing hole for sleeving on the convex column.

6. The battery connector according to claim 5, wherein first cover further comprises a fixing member, the fixing member is connected to the convex column, the second cover comprises a positioning member, and two ends of the elastic member are respectively sleeved on the fixing member and the positioning member.

7. The battery connector according to claim 1, wherein the at least two guiding columns are fixed in the guiding holes in a fasten state, and the at least two guiding columns are configured to slide in the guiding holes in a release state.

8. The battery connector according to claim 7, wherein each of the guiding columns comprises an outer guiding rod and an inner guiding rod inserted in the outer guiding rod, and the inner guiding rod moves relative to the outer guiding rod so as to configure the guiding columns and the guiding holes in either one of the fasten state and the release state.

9. The battery connector according to claim 8, wherein each of the guiding columns further comprises a rolling ball arranged on the outer guiding rod and exposed outside an outer surface of the guiding column, the inner guiding rod comprises a fasten portion and a release portion; when the fasten portion pushes the rolling ball outward to abut against the guiding hole, the guiding columns and the guiding holes are in the fasten state; and when the rolling ball is located at the release portion to reduce a resistance to the guiding hole, the guiding columns and the guiding holes are in the release state.

10. The battery connector according to claim 9, wherein the outer guiding rod comprises an accommodated hole penetrating through the outer guiding rod in a radial direction, the rolling ball is arranged in the accommodated hole, and the inner guiding rod pushes the rolling ball to protrude from the accommodated hole and be fastened to the guiding hole.

11. The battery connector according to claim 9, wherein the fasten portion is extended from the release portion along the axial direction, a diameter of the release portion is smaller than a diameter of the fasten portion.

12. The battery connector according to claim 10, wherein each of the guiding columns further comprises a spring and a snap ring, the spring is sleeved on the outer guiding rod, and two ends of the spring respectively abut against the terminal holder and the snap ring.

13. The battery connector according to claim 12, wherein each of the guiding columns further comprises a washer sandwiched between the spring and the snap ring.

14. The battery connector according to claim 10, wherein each of the guiding columns further comprises a sleeve, the outer guiding rod comprises a concave area corresponding to the accommodated hole, the sleeve sleeves on the concave area and comprises an opening located on a radial direction for partially exposing the rolling ball.
